(19) United States
(12) Patent Application Publication
(10) Pub. No.: US 2010/0303693 A1
(43) Pub. Date: Dec. 2, 2010

(54) HYBRID SOLVENT USING PHYSICAL SOLVENTS AND NANOPARTICLE ADSORBENTS

(75) Inventor: Dennis Leppin, Chicago, IL (US)

Correspondence Address: MARK E. FEJER;GAS TECHNOLOGY INSTITUTE, 1700 SOUTH MOUNT PROSPECT ROAD, DES PLAINES, IL, 60018, US

(73) Assignee: GAS TECHNOLOGY INSTITUTE, Des Plaines, IL (US)

(21) Appl. No.: 12/500,635

(22) Filed: Jul. 10, 2009

Related U.S. Application Data
(60) Provisional application No. 61/183,130, filed on Jun. 2, 2009.

(51) Int. Cl. B01D 53/62; B01J 8/18

(52) U.S. Cl. 423/230; 422/140

(57) ABSTRACT

A hybrid solvent combining a physical solvent with particles of solid adsorbent for separation of components of a gas mixture, wherein both the physical solvent and the solid adsorbent particles are suitable for preferential removal of the components of interest.

### CROSS-REFERENCE TO RELATED APPLICATION This application claims the benefit of an earlier filed provisional application having Ser. No. 61/183,130 and a Filing Date of 02 Jun. 2009.

### BACKGROUND OF THE INVENTION

1. Field of the Invention

This invention relates to a process and system for separation of components of a gas mixture utilizing physical solvents and solid adsorbent particles. In one aspect, this invention relates to a method for increasing the solubility of a physical solvent. In one aspect, this invention relates to a process and system for separation of components of a gas mixture which provides additional capacity to existing process installations in which the capacity has been reached. In one aspect, this invention relates to a process and system for the enrichment of desired components of a gas mixture relative to undesired components.

2. Description of Related Art

Gas mixtures comprising a plurality of gaseous components, e.g. CH₄ and CO₂, CO₂ and H₂S, etc., often require the separation of the components to produce a desired product. Physical solvents pumped into towers packed with mass transfer enhancing devices, or sprayed into empty towers or vessels are the primary means by which a gas component of a gas mixture is removed from other non- or lesser-absorbing components of the gas mixture. Examples of physical solvents presently in use, mainly for CO₂ and H₂S removal, include methanol, N-Methylpyrrolidone (NMP), N-formyl and N-acetyl morpholine mixtures, and dimethyl ether of polyethylene glycol, and there are numerous others. Another example of a physical solvent is triethylene glycol used in dehydrating plants.

Physical solvents are used when partial pressure on an absorbed component is sufficiently high, usually because the pressure as well as the concentration are high. The solubility of the component in a solution at a given pressure and temperature determines the necessary circulation rate of the solvent, which influences the size of the contacting equipment and the energy required to pump the solvent between the solvent regeneration section and the absorption section. Because this is a physical property of the solvent, there is no way to increase the solubility of the solvent.

Adsorbents are solids which allow layers of gaseous components to adhere to the surface of the solid by various molecular forces. Some adsorbent solids are highly specific to specific components, e.g. water or CO₂, and adsorb proportionately more of such components than other adsorbent solids.

Solid adsorbents are used alone in Pressure Swing Adsorption (PSA) or Temperature Swing Adsorption (TSA) processes in which numerous beds are operated in overlapping cycles of adsorption, desorption, heat up, and so on, in order to effect a nearly continuous means of adsorbing a component of interest. A molecular sieve is a material containing tiny pores of a precise and uniform size that is used as an adsorbent for gases and liquids. Molecules small enough to pass through the pores are adsorbed while larger molecules are not. This is different from a common filter in that operation is on a molecular level. For example, a water molecule may be small enough to pass through whereas larger molecules are not. As a result, molecular sieves often function as a desiccant. A molecular sieve can adsorb water up to about 22% of its own weight. Often they consist of aluminosilicate minerals, clays, porous glasses, microporous charcoals, zeolites, active carbons, or synthetic compounds that have open structures through which small molecules, such as nitrogen and water, can diffuse.

### SUMMARY OF THE INVENTION

It is one object of this invention to provide a process and apparatus for separation of components of a gas mixture utilizing a physical sorbent with increased solubility over conventional physical sorbents.

It is another object of this invention to provide a process and apparatus for separation of components of a gas mixture which is able to provide additional capacity to existing process installations in which the capacity has been reached.

These and other objects of this invention are addressed by a contactor system for separation of components in a gas mixture comprising a hybrid solvent comprising a mixture of a physical solvent and particles of a solid adsorbent substantially uniformly dispersed within said physical solvent. Both the physical solvent and the solid adsorbent preferentially remove the same component of interest from the gas mixture. By mixing a physical solvent and solid adsorbent particles in a stable mixture, i.e. one that does not readily settle out the solids, more of the preferred gas mixture component, i.e. the gas component of interest, can be absorbed plus adsorbed in the resulting combined (hybrid) mixture of a given volume. In this way, the solubility of the physical solvent is effectively increased.

This invention may also be employed when an existing process installation reaches capacity and additional capacity is required. By increasing the sorption capacity of the solvent without substantially increasing the flow rate required, more expensive debottlenecking, e.g. building a second plant, adding pumps and additional absorber and/or stripper towers may be avoided.

### DESCRIPTION OF THE PRESENTLY PREFERRED EMBODIMENTS

As used herein, the term “hybrid solvent” refers to a mixture or combination of a physical solvent and a solid adsorbent, where both the physical solvent and the solid adsorbent preferentially remove the same component or components from a gas mixture. The hybrid solvent of this invention will have a higher solubility and selectivity for a component of interest of a gas mixture than would be expected based on the use individually of either the physical solvent or the solid adsorbent in the conventional manner. For a given volume of hybrid solvent, the solubility of components desired to be removed from a gas mixture may be considerably higher. This is because the adsorbent holds a large fraction of its weight as adsorbent with no increase in volume as a result of such adsorption and solids are much denser than liquids; thus the displaced volume of solvent would have held lesser amounts of the component to be removed than the solid adsorbent.

If the solvent is non-selective to an undesired component A in a mixture with preferred component B, that is, a component desired to be absorbed and adsorbed in the hybrid solvent of this invention, the relative concentrations of components A and B adsorbed onto the adsorbent will also be lower. The amounts adsorbed result in lower concentrations in the physical solvent, which will then absorb more of the desired component B in the absorber vessel or system. When the components are desorbed, the relative proportions of the desired component to undesired components will be enriched compared to what could be obtained with the physical solvent alone. This enrichment reduces the number of transfer stages (height of vessel, volume of packing) and reduces the cost of the system. Enrichment is of great value; for example, in the separation of H₂S and CO₂ from natural gas, it is important to generate a concentrated off gas to feed a Claus unit which requires an H₂S to CO₂ ratio greater than the H₂S to CO₂ in the feed to the absorber unless the H₂S is already above 50% concentration in the feed.

The use of adsorbents alone often results in co-adsorption of other components when the adsorbent has a propensity for those components. For example, molecular sieve Type 4A (pore size 4Å) adsorbs H₂O, CO₂, SO₂, H₂S, C₂H₄, C₂H₆, C₃H₆ and ETOH. These components, if present, are then desorbed and commingled with the desired product requiring further steps for removing such components or, in the event it is a waste product, the inability to discharge to the atmosphere, e.g. due to excessive hydrocarbons being commingled with a component otherwise permissibly discharged (water, CO₂). The selective properties of the solvent may prevent undesired co-contaminants from being adsorbed as they will not be present in the solution to begin with.

Particle sizes of the adsorbent need to be selected in such a manner that a stable solution, i.e. one in which the particles do not settle out, is produced and the viscosity of the solution is not unduly increased. The particles need to have sufficient solution binding energy, surface tension, and similar properties that they will not be excessively carried off with the gas phase in the contactor. The particles should also not be of such size and concentration that they have adverse effects on materials erosion or pump or expander operability. In accordance with one embodiment of this invention, to avoid the aforementioned practical difficulties, the particles of solid adsorbent are nanosized particles. As used herein, the terms “nano”, “nanosize”, “nanoparticles”, “nano-sorbent”, and “nano-materials” refer to particle sizes less than or equal to about 100 nanometers.

It is to be understood that materials other than molecular sieves may be used in the hybrid solvent of this invention provided that they have the desired property of adsorbing the same component that is preferentially absorbed by the physical solvent, and such other materials are deemed to be within the scope of this invention.

If selectivity is desired between two components, A and B, the adsorbent should be selected from those which preferentially adsorb component B if the solvent absorbs B preferentially to A, thus amplifying the overall selectivity compared to the solvent alone. If a solvent is used that is undesirably preferential to B over A, selecting an adsorbent which preferentially or exclusively adsorbs A will moderate that selectivity. That is, in the former instance, B might be H₂S and A CO₂, and it may be desired to separate these to produce an enrichment of H₂S to CO₂ by using an adsorbent in the solvent exclusive to H₂S, for example one based on iron. For example, MORPHYSORB® solvent, which is used to process natural gas, preferentially absorbs CO₂ and H₂S, but if ethane is present in large concentrations, it is not absorbed as strongly so that MORPHYSORB normally enriches the feed gas by not absorbing the ethane in any significant quantity. The ethane stays with natural gas when H₂S and CO₂ are being removed therefrom. Type 4A molecular sieve adsorbs ethane so it would normally be a poor choice to remove CO₂ and H₂S from natural gas containing ethane due to co-adsorption and attendant losses of ethane from the sales gas. By using the hybrid solvent of this invention, ethane will not co-adsorb on the molecular sieve, thereby producing the desired enhancement of the solubility of MORPHYSORB and reduction in required solvent rates, pumping horsepower, and absorber/desorber sizes. It will be appreciated that this is but one example and that the hybrid solvent of this invention is broadly applicable to various separations provided appropriate adsorbents and solvents can be identified, the key criteria being the ability of the adsorbent and the solvent individually and in combination to absorb/adsorb significant amounts of at least one of the same components which is desired to be removed from the gas mixture.

Conventional adsorbent processes may suffer from the effects of decrepitation of the molecular sieve material over time, which leads to the collapse of the fixed beds in which such materials are typically placed. Since the sieve material will be used in fine sizes in the present invention, such decrepitation and size reduction will either not occur or cause little change in the operation of the process. If activity of the sieve material is reduced over time due to poisoning, it could be easily introduced in a concentrated slurry without any necessary shutdown to the process in contrast to conventional adsorbent processes, which require a lengthy shutdown to replace sieve material. A further advantage of this invention is that the heat of adsorption of sieve material or other adsorbents results in heating of the adsorbent bed, which results in lowering the amount of adsorption of desired gas on the material. By encasing such sieve material in a solvent, the heat capacity of the solvent will moderate the temperature rise that would otherwise occur, resulting in higher adsorption and, thus, increased effectiveness.

In accordance with one embodiment of the process of this invention, the hybrid solvent described herein above is disposed within a conventional absorption/stripping apparatus. This involves pumping the solvent to the top of a tower that is usually filled with packing materials to enhance contact and mass transfer, allowing the gas mixture and solvent to commingle in the tower, resulting in the desired separation, and then directing the loaded or rich hybrid solvent to a stripping device in which absorbed/adsorbed components are driven off, enabling the solvent to be reused. Typical means of stripping the solvent include applying heat, reduction in pressure, application of a vacuum, and introduction of a stripping gas. The desorption processes that take place must have desorption effectiveness on both the dissolved adsorbent as well as the physical solvent at substantially similar conditions. For example, as it is known that molecular sieves can be operated in both pressure swing and temperature swing modes, reducing pressure or heating the rich solution will both be effective in regenerating the hybrid solvent.

It will be appreciated that the hybrid solvent of this invention may be readily employed in other known solvent contacting schemes. For example, direct injection of the solvent into a flowing gas stream, use of a venturi to entrain the solvent into a gas stream, spraying solvent in an empty tower, and bubbling gas into a volume of the solvent contained within a vessel are all well-known to those skilled in the art and the hybrid solvent of this invention may be employed in any of these contacting schemes as well as others not specifically set forth herein.

It will be appreciated that there is a potential for the solid adsorbent particles in the physical solvent to settle out over time. This issue may be addressed by the continuous circulation of the hybrid solvent through a pump and flashing across a valve ex absorber. A few purges of process or inert gas at dead spots in the flash tank will allow for redistribution of the particles after shutdowns or other periods of low circulation. Furthermore, the use of countercurrent contact of the gas mixture with the hybrid solvent produces vigorous agitation. In the flash tank, the dissolved vapors leaving the hybrid solvent also produce adequate circulation. In addition, depending upon the surface tension of the materials and their size, such settling may not even occur and it would be the intention to formulate hybrid solvents that avoid such settling if possible. This may be achieved, for example, by the addition of surface moieties on the solids.

### EXAMPLE

In this example, triethylene glycol (TEG) is used for dehydration of natural gas. TEG is circulated to an absorber and absorbs water from the gas. The TEG is then sent to a stripper where it is heated (usually by firing natural gas and convectively heating the rich TEG) to approximately 200° C. (392° F.). This is the maximum temperature before excessive degradation of the solution would occur. The resulting lean TEG reaches 98.6% TEG, with the balance being H₂O. This concentration of solution is sufficient to achieve certain levels of dewpoint depression, but, for demanding applications, additional complex and costly steps are necessary. A molecular sieve dehydration material in nano-particle form is added to create a stable solution in the TEG. One of the criteria for determining the maximum amount that may be added is solution viscosity. In this example, 20% by weight of molecular sieve dehydration material is added. This amount of Type 4A sieve can hold 20% water by weight, or 4% water relative to the total solution weight. TEG is usually used (economically) at 3 gallons per pound of H₂O removed, so it will pick up some 5% H₂O by weight. If the mass transfer to the dissolved molecular sieve material is sufficiently rapid to allow the sieve to reach equilibrium, the overall solution will now be able to pick up approximately 10% water at the same 3 gal/lb rate. The molecular sieve material may be regenerated by elevated temperature and pressure reduction and, thus, can be expected to regenerate in the stripper along with the TEG.

Thus, in this process, the circulation rate can be reduced by a factor of two. The heat of regeneration has been reduced, as the heat capacity of the 20% sieve material in the solution will be less, by more than four times, the roughly four times as much TEG (at 20% nanoparticle concentration) that needs to be heated up since the heat capacity is lower (but this is only the sensible heat component which is far outweighed by the heat of solution or latent heat which will not change to that extent). The lean TEG solvent may also attain a lower moisture level than the comparable process without the hybrid solvent if the molecular sieve inherently adsorbs some of the equilibrium moisture of the TEG as the solution is cooled down prior to being fed to the absorber. The higher TEG concentration of the solution will enable lower dewpoints of the treated gas, avoiding complex approaches such as stripping gas in the regenerator, or extreme commercial processes such as DRIZO® and COLDFINGER®.

### EXAMPLE

In this example, CO₂ is removed from flue gas. The primary approach, and the only proven approach at industrial scale, is the use of a monoethanolamine (MEA) solvent in an absorber/stripper system. MEA solution concentration is limited to 30% or so, which fixes the amount of solvent circulation that is required. By adding a molecular sieve which can adsorb CO₂, e.g., Type 13X or 5A, the absorption capacity for CO₂ of MEA solvent is enhanced in much the same way as described above for water removal using TEG.

### EXAMPLE

Yet another example is a hybrid solvent comprising a physical solvent which can jointly absorb H₂S and CO₂, such as DEA or other amine, or physical solvent such as dimethylether of polyethylene glycol (SELEXOL®). By adding a nano-adsorbent with a propensity for H₂S, e.g. an iron-based material, but not CO₂, the solvent will absorb relatively more H₂S as a whole. It will, upon regeneration, liberate a stream relatively richer in H₂S than before. By tailoring this “selectivity”, one can produce a stream rich enough for a Claus plant (50 vol % or more H₂S), thus avoiding use of expensive selective proprietary solvents, e.g., CS1000 or FLEXSORB®, as well as expensive and high operational cost liquid redox processes or multi-stage contacting schemes.

### EXAMPLE

Another example involves adding a nano-material that can scavenge undesirable components in the solvent. In amine processes, there is a buildup of degradation products, usually containing oxygen, such as oxalates and large molecular weight compounds such as THEED (tris hydroxyethyl ethylenediamine) and HEED (hydroxyethyl ethylenediamine). By blending in an appropriate adsorbent for these materials, their adverse effects can be rendered neutral and the possibility of their removal, say by a hydroclone on a slipstream of solution, would be afforded.

### EXAMPLE

Yet another example involves adding non-regenerative nano-materials in the solvent to remove trace undesirable components. In flue gas, trace quantities of NOₓ, SOₓ, mercury and others remain in the gas stream even after conventional clean-up systems. A nano-material scavenger can chemically adsorb the contaminant and be removed from the liquid stream for either recovery or disposal.

Another feature of this invention is the possibility of regeneration in stepwise fashion depending on the conditions and relative kinetics of solvent mass transfer and sorbent desorption steps. In a first stage of such a process, conditions can liberate the absorbed constituents from the solvent. This is then followed by a second stage desorption at conditions, perhaps by adding more heat or lowering the pressure or just due to providing more desorption time, of desorbing the constituents on the nano-sorbent and thus producing a stream enriched in the component adsorbed by the nano-sorbent.

While in the foregoing specification this invention has been described in relation to certain preferred embodiments thereof, and many details have been set forth for purpose of illustration, it will be apparent to those skilled in the art that the invention is susceptible to additional embodiments and that certain of the details described herein can be varied considerably without departing from the basic principles of the invention.

What is claimed is:

1. A method for separation of components in a gas mixture comprising the steps of:
mixing a physical solvent suitable for preferentially absorbing a component of interest in said gas mixture with particles of a solid adsorbent suitable for preferentially adsorbing said component of interest, producing a hybrid solvent; and
contacting said hybrid solvent with said gas mixture, resulting in removal of at least a portion of said component of interest.

2. The method of claim 1, wherein said particles of said solid adsorbent are substantially uniformly distributed in said physical solvent.

3. The method of claim 1, wherein said particles of solid adsorbent have a particle size less than or equal to about 100 nanometers.

4. The method of claim 1, wherein said gas mixture comprises natural gas and water, and said component of interest is said water.

5. The method of claim 4, wherein said hybrid solvent comprises triethylene glycol and a molecular sieve dehydration material.

6. The method of claim 1, wherein said gas mixture is a flue gas and said component of interest is CO₂.

7. The method of claim 6, wherein said hybrid solvent comprises monoethanolamine and a molecular sieve suitable for adsorbing said CO₂.

8. The method of claim 1, wherein said gas mixture comprises a plurality of components of interest, said physical solvent preferentially absorbs said plurality of components of interest, and said particles of said solid adsorbent preferentially adsorb one of said plurality of components of interest.

9. The method of claim 1, wherein contacting of said gas mixture and said hybrid solvent is achieved with counterflow streams of said gas mixture and said hybrid solvent.

10. The method of claim 1, wherein said gas mixture is bubbled through said hybrid solvent.

11. The method of claim 1, wherein said hybrid solvent is directly injected into a gas stream comprising said gas mixture.

12. The method of claim 1, wherein a venturi is used to entrain said hybrid solvent into a gas stream comprising said gas mixture.

13. A gas contactor system for separation of components in a gas mixture comprising:
a hybrid solvent comprising a mixture of a physical solvent suitable for preferentially absorbing a component of interest in said gas mixture and particles of a solid adsorbent suitable for preferentially adsorbing said component of interest, said particles of said solid adsorbent substantially uniformly distributed within said physical solvent.

14. The gas contactor of claim 13, wherein said particles of said solid adsorbent have particle sizes less than or equal to about 100 nanometers.

15. A method for increasing the solubility of a physical solvent for removing a component of a gas mixture comprising the steps of:
mixing a physical solvent suitable for preferential removal of said component with particles of a solid adsorbent suitable for preferentially adsorbing said component, whereby said particles of solid adsorbent are substantially uniformly dispersed throughout said physical solvent.

16. The method of claim 15, wherein said particles of said solid adsorbent have particle sizes less than or equal to about 100 nanometers.
